(19) United States
(12) Patent Application Publication
(10) Pub. No.: US 2015/0127813 A1
(43) Pub. Date: May 7, 2015

(54) CONTEXTUAL BROWSER COMPOSITION AND KNOWLEDGE ORGANIZATION

(71) Applicants: Hong Li, El Dorado Hills, CA (US); Mark Yarvis, Portland, OR (US); Sharad Garg, Portland, OR (US); Joshua Boelter, Portland, OR (US)

(72) Inventors: Hong Li, El Dorado Hills, CA (US); Mark Yarvis, Portland, OR (US); Sharad Garg, Portland, OR (US); Joshua Boelter, Portland, OR (US)

(21) Appl. No.: 14/129,774

(22) PCT Filed: Nov. 7, 2013
(86) PCT No.: PCT/US2013/068920

§ 371 Date: Dec. 27, 2013

(51) Int. Cl. H04L 29/08; G06F 17/30

(52) U.S. Cl. CPC H04L 67/22; G06F 17/30876
USPC 709/224

(57) ABSTRACT

Various systems and methods for organizing knowledge are described herein. A context of a browsing session of a plurality of online resources is identified. User browsing behavior during browsing of the plurality of online resources is tracked. Using a computing device, a relevance metric of the plurality of online resources is determined using the user browsing behavior, with the relevance metric measuring a relevance of the plurality of online resources in view of the context. The relevance metric, an indicia of the context, and the plurality of online resources are stored in a database on the computing device.

### TECHNICAL FIELD

Embodiments described herein generally relate to data collection and organization and in particular, to a system and method for contextual browser composition and knowledge organization.

### BACKGROUND

In the electronic age, research is augmented with online materials. Online systems such as search engines, libraries, discussion forums, and encyclopedias provide access to an enormous amount of information. However, with this amount of information, it is easy to lose track of sources with relevant or important information.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to organize knowledge, according to an embodiment;

FIG. 2 is a schematic diagram of a system for organizing knowledge, according to an embodiment;

FIG. 3 is a flowchart illustrating a method for organizing knowledge, according to an embodiment; and

FIG. 4 is a block diagram illustrating an example machine upon which any one or more of the techniques (e.g., methodologies) discussed herein may perform, according to an example embodiment.

### DETAILED DESCRIPTION

The amount of content accessible via the Internet is staggering. With hundreds of millions of websites, some containing millions of documents, videos, or other electronic content, a person browsing even a minute subset of this data may become lost and overwhelmed. What is needed is a mechanism to store and provide relevant content to a user.

An example embodiment includes a mechanism to provide dynamic compositions in a browser display that suits an individual user's need based on user contextual information. Contextual information may include hyperlinks the user followed in a previous or current browsing session, what information was presented to the user in a previous or current browsing session, how the user acted while browsing the presented information, and other user actions during browsing. Contextual information may be collected with hardware or software sensors, such as cameras, eye tracking devices, keyboard monitors, or mouse activity monitors. After collecting contextual information, the browser may be intelligently and dynamically organized with various views to present relevant information.

A “browser” refers to a software application that provides online content of an online resource to a user in an organized manner and that allows the user to navigate or “browse” through the online content. Examples of browsers include, but are not limited to Microsoft® Internet Explorer®, Google Chrome™, Apple Safari®, and Mozilla® Firefox®. Browsers may be adapted for mobile platforms (e.g., a smartphone-specific browser or a tablet browser).

A “browsing session” refers to a time period of roughly contiguous browsing. The browsing session may include browsing of related topics or online content, or may be of various unrelated or tangentially related topics or online content. A browsing session may last as short as a few seconds or as long as several hours. A browsing session may be initiated by executing a browser (or a tab in a browser) and then terminated when the browser (or tab) is closed.

While a browsing session may refer to navigation among a plurality of web pages in a browser, it is understood that a browsing session may also refer to browsing content using various network applications. A network application is an application that access information from a network source (e.g., from the Internet). For example, a smartphone may include network applications that are tailored or specific to certain content providers, such as Facebook®, Skype®, LinkedIn®, Netflix®, or the like. Browsing in the mobile device context then is using these network applications (exclusive from or in addition to a browser) to access, e.g., browse, content. In this arrangement, a framework may be implemented to intercept content from the various sources and organize it according to the examples described in this document.

“Online content” refers to content that is accessible with a browser via a network. Online content includes, but is not limited to web pages, file transfer protocol (FTP) sites and content, newsgroups, document archives, email repositories, video repositories, and the like. Various protocols may be used to access online content including, but not limited to hypertext transfer protocol (HTTP), simple mail transfer protocol (SMTP), file transfer protocol (FTP), or network news transfer protocol (NNTP).

“Online resource” refers to a source of online content. Examples of online resources include, but are not limited to web pages, email servers, newsgroup servers, FTP servers, and the like.

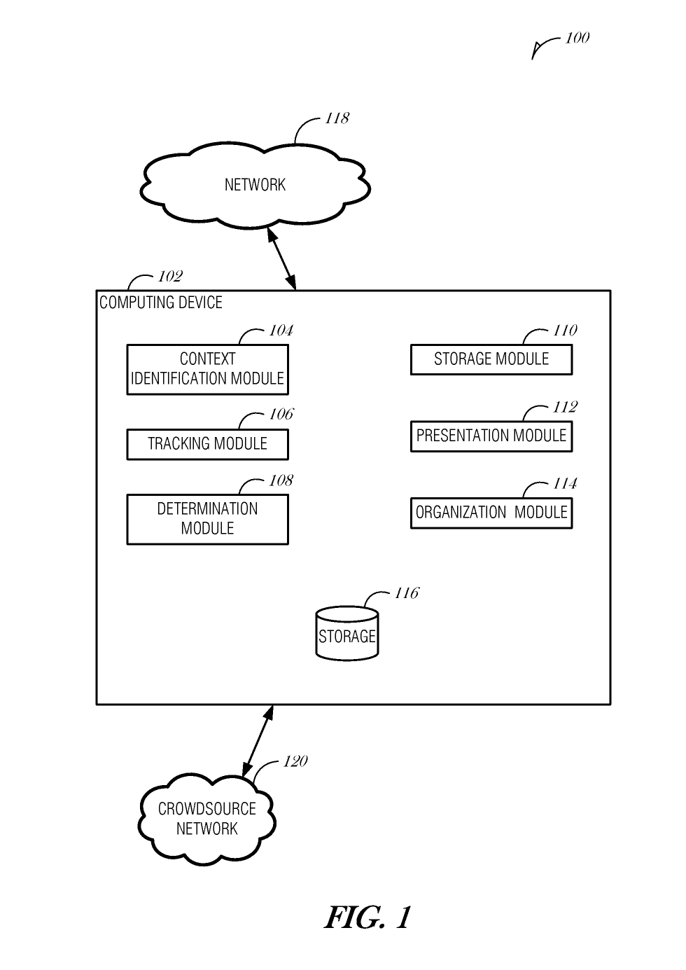

FIG. 1 is a schematic drawing illustrating a system 100 to organize knowledge, according to an embodiment. The system 100 includes a computing device 102, which may be a computer system and may be worn or carried by a person. In various embodiments, the computing device 102 is a wearable device (smart watch, smart glasses, etc.), smartphone, laptop, desktop, tablet computer, hybrid tablet, or other processor-based system or device. The computing device 102 includes a context identification module 104, a tracking module 106, a determination module 108, a storage module 110, a presentation module 112, and an organization module 114. The computing device 102 also includes a storage device 116, which may be of any memory type, such as random access memory (RAM), magnetic disk storage media, optical storage media, flash-memory devices, or other types of storage devices or media. The storage device 116 may be of various form factors, such as a secure digital (SD™) card, a CompactFlash® (CF) card, or a universal serial bus (USB) drive. The storage device may include various data structures for storing data, such as a database or a file system.

Using the computing device 102, a user may access online resources via a network 118. Optionally, a crowdsource network 120 may be used to track browsing content and behavior of multiple users, with such data used in the determination of what is or may be useful or interesting to the user of the computing device 102.

In an embodiment, the context identification module 104 is arranged to identify a context of a browsing session of a plurality of online resources. Context of a browsing session may be identified in various ways, such as by a user action (e.g., searching for particular content or browsing several web pages with similar or related topics). In an embodiment, identifying the context comprises identifying a keyword used in a search string. The search string may be provided by a user in a browser search field. For example, the browser's address field may be configured to perform a search at a search engine when unformatted content is provided in the address field. As another example, the browser may provide a search input control as a portion of the browser's user interface, which when used navigates the user to a search engine (e.g., Google® or Microsoft® Bing®) to perform the search and display the results. Alternatively, the user may search after navigating to a search engine (e.g., www.google.com).

In another embodiment, identifying the context comprises identifying a common topic among the plurality of online resources. For example, a user may be interested in diagnosing foot pain. In order to do so, the user may access several online medical resources and search for symptoms. The online addresses, search input, or other aspects of the browsing session may be tracked and correlated to determine a likely theme or topic. The topic may then be consider the context (or at least one context) of the browsing session.

When the user visits the page and reviews the page's content, the user's behavior may be monitored or tracked. By recording and analyzing how the user interacts with the page, the system 100 may determine what content is most interesting to the user and as a result may infer what content is most interesting with respect to the browsing context. Thus, in an embodiment, the tracking module 106 is arranged to track user browsing behavior during browsing of the plurality of online resources. Content-specific applications that are executable separate from a browser may also be monitored. Such information may be provided by the crowdsource network 120. By monitoring many users, the system 100 may be able to make stronger inferences about browsing context and importance or interest of online content. In an embodiment, the user browsing behavior comprises browsing behavior of a plurality of users.

One or more users may be monitored or tracked using various technologies incorporated into the browser or the device used by the user. In an embodiment, tracking the user browsing behavior comprises using a hardware-based sensor to determine a portion of interest of an online resource. The hardware-based sensor may comprise an eye tracking device and in this case, tracking the user browsing behavior comprises tracking a user's eye movement to determine the portion of interest. For example, when tracking a user's eye movement, the system 100 may detect that the user's eyes are relatively stationery for a period of time, indicating that the user is studying a portion of online content intently. By interfacing with the browser, the portion may be identified so that the correlation may be identified and stored. Alternatively or in addition to, the hardware-based sensor may comprise a motion detector and in this case, tracking the user browsing behavior comprises sensing user motion and correlating the user motion with the portion of interest. Motion detection may provide insight into whether a user is attentive, distracted, interested, or the like. User motion may useful to corroborate with other sensor inputs to determine user interest in online content.

A relevance metric may be used to measure the relevance of the online content from online resources. The relevance metric may be based on various factors, such as how long a person views online content or how many people with the same or similar browsing context have viewed the online content. In an embodiment, the determination module 108 is arranged to determine a relevance metric of the plurality of online resources using the user browsing behavior, the relevance metric measuring a relevance of the online resource in view of the context.

In an embodiment, the storage module 110 is arranged to store the relevance metric, an indicia of the context, and the plurality of online resources in a database on the computing device. Storing such information allows the browser to present the online resources to the user at a later time, such as during a subsequent browsing session, or allows the user to save the information to another format, such as a word processing document or a spreadsheet document. In the context of browsing content using network applications, a designated application may be used to present the resources to the user at a later time. The designated network application may be a browser or another network application.

After a browsing session is complete, the user may be interested in accessing the most interesting online content again in a second (or later) browsing session. Determining when a browsing session is complete may be performed by various mechanisms, such as by determining that a user has closed or exited the browser, determining that the user has shut down or powered off the device, detecting that the device is in sleep mode or another suspended state, or the like. When the user reengages the device and the browser in another browsing session, the browser may provide a mechanism (e.g., hyperlinks) for the user to quickly access the previously-browsed content. In an embodiment, the presentation module 112 is arranged to present the portion of interest of a respective online resource during a second browsing session.

In an embodiment, the presentation module 112 is arranged to present at least a portion of the plurality of online resources as one or more hyperlinks to navigate the user to the portion of interest of the respective online resource. In a further embodiment, the presented plurality of online resources is ordered according to the relevance metric. In a further embodiment, the presentation module 112 is arranged to present the portion of interest by automatically scrolling the online resource to a point where the portion of interest is visible. This mechanism brings the content into view for the user. In an embodiment, the presentation module 112 is arranged to present the portion of interest by presenting a colored indicator in a scroll bar indicating a relative position of the portion of interest in the online resource. For example, a green tick mark may be displayed in a scroll bar to indicate a more relevant portion of content and a yellow tick mark may be displayed in the scroll bar to indicate a slightly less relevant portion. Multiple tick marks may be presented concurrently on a scroll bar.

In an embodiment, the organization module 114 is arranged to organize the plurality of online resources based on the relevance metric. The computing device 102 may then present the organized plurality of online resources at the computing device via the presentation module 112.

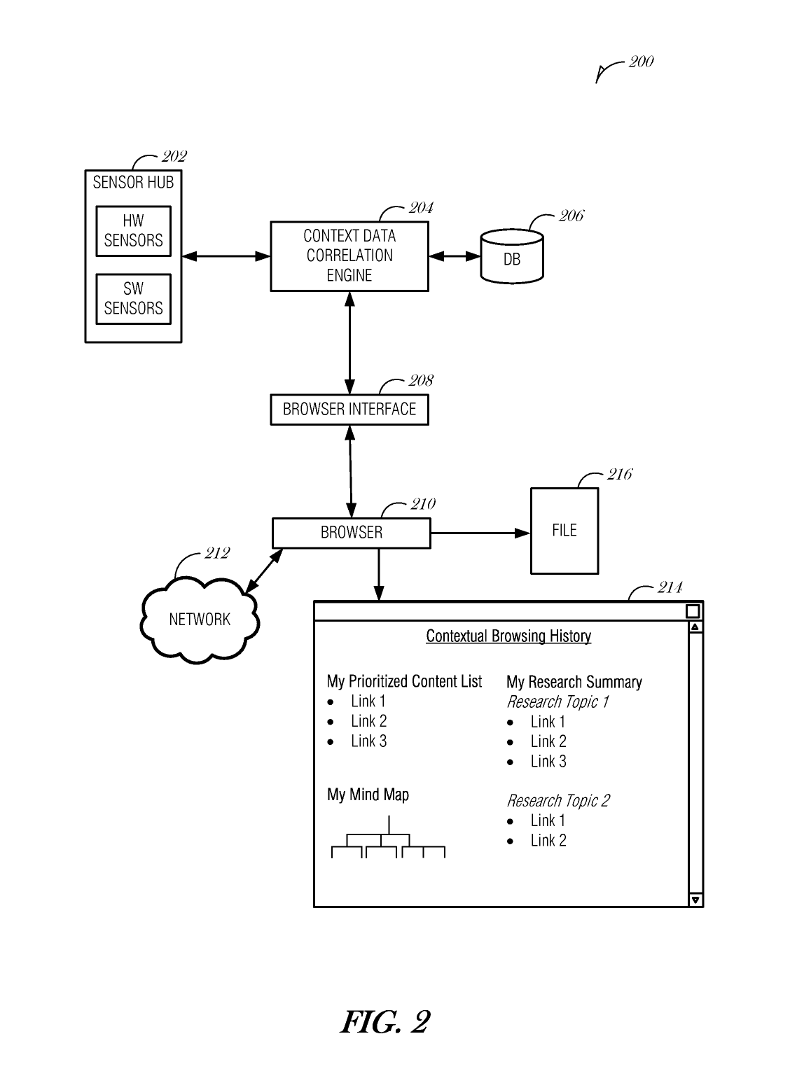

FIG. 2 is a schematic diagram of a system 200 for organizing knowledge, according to an embodiment. The system 200 includes a sensor hub 202, a data correlation engine 204, a database 206, a browser interface 208, and a browser 210. The browser interface 208 may be implemented as a browser plug-in (or add-on), firmware, or a separate client application.

The sensor hub 202 may include hardware or software sensor. Hardware sensors may include devices to track various data, such as location (e.g., global positioning system (GPS)), motion (e.g., infrared device), connectivity, eye gazing (e.g., camera), gesture, etc. Software sensors may include software, firmware, or other mechanisms to track the time, time on page, current browsing activity, mouse or pointer movement, browsing history, keyboard input, etc.

In operation, while the user is browsing online content via the browser 210 on the network 212, the browser interface 208 intercepts or accesses requests from a user for online content. The browser interface 208 may also intercept or access any content delivered as a result of the request. The browser interface 208 may identify the location of the requested content (e.g., universal resource locator (URL)), the time of the request, the querystring of the request, or other aspects of the request. Data intercepted or accessed by the browser interface 208 may be stored in the database 206.

When the user has accessed online content, one or more various sensors from the sensor hub 202 may monitor or track the user's behavior. The context data correlation engine 204 tracks the portions of online content the user is viewing and correlates it with the sensor activity, as obtained from the sensor hub 202, to identify and infer interesting portions of online content relevant to a particular browsing context. The contextual information is stored in the database 206.

When the user begins a later browsing session, the context data correlation engine 204 may retrieve previously-accessed online content and working with the browser interface 208, display a window 214 with the online content arranged in an organized output. For example, the window 214 may display recent topics based on browsing context. The topics may include hyperlinks organized based on the relevance of the online resource with respect to the browsing context. The output displayed in the window 214 may be in various arrangements including, but not limited to, a prioritized content list, a research summary, or a mind map. The prioritized content list may include links that are determined to be highly relevant. The prioritized content list may be sorted from a highest relevance to a lower relevance. The research summary may be a prioritized content list constrained to one or more research topics. The research topics may be based on a user's browsing context, such as one or more keywords used in one or more searches, for example. The mind map may include a plurality of related topics linked in a hierarchy (e.g., from a general topic at the root of the mind map to a more specific topic in the branches and leaves of the mind map). Icons displayed in the mind map may navigate the user to specific online resources.

Additionally, the user may store certain user preferences in the database 206. User preferences may include page display preferences or policies. For example, the user may indicate to only display up to a week's worth of history or to only display up to five online resources per topic.

In an embodiment, the window 214 may display content from a crowdsourced database. For example, if the user of the system 200 had previously searched for online resources describing how to repair a broken faucet, the system 200 may access a crowdsourced database to determine what resources others have used to address the same or similar issue. The crowdsource information may be presented with an indicator near the hyperlink (e.g., an icon indicating that the hyperlink is from a community resource, not the user's own browsing history). Alternatively or additionally, the crowdsourced data may be presented in a separate area of the window 214 (e.g., under its own heading).

When a user follows a hyperlink presented in the window 214 to a previous-visited online resource, the browser interface 208 may intercept the navigation request and then when the online content is displayed, work with the browser 210 to display the relevant portion. For example, the browser interface 208 may navigate the user to the particular portion (e.g., auto-scroll so that the content is in view) or add an indicator (e.g., colored bar) on the scroll bar to indicate the content's location.

The browser 210 may also output a file 216 with the content maintained by the context data correlation engine 204. For example, a word processing document may be output and may be organized to appear with hyperlinks, tables, headers, and other aspects that make the document appear similar to the output that may be presented in the window 214. As another example, a spreadsheet document may be output with the content arranged in various cells in the spreadsheet.

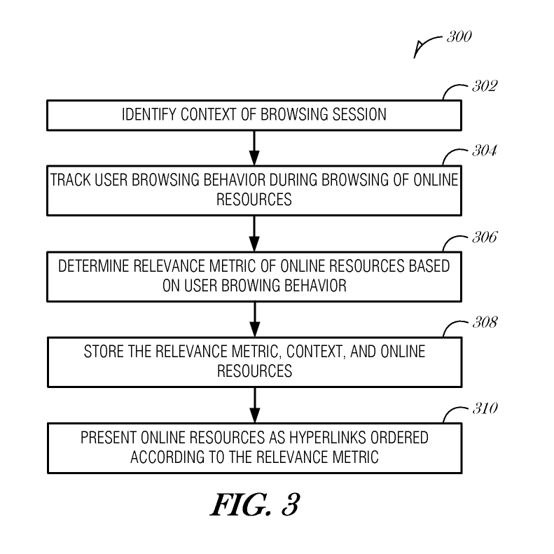

FIG. 3 is a flowchart illustrating a method 300 for organizing knowledge, according to an embodiment. At block 302, a context of a browsing session of a plurality of online resources is identified. In an embodiment, identifying the context comprises identifying a keyword used in a search string. In an embodiment, identifying the context comprises identifying a common topic among the plurality of online resources.

At block 304, user browsing behavior during browsing of the plurality of online resources is tracked. In an embodiment, the user browsing behavior comprises browsing behavior of a plurality of users. In an embodiment, tracking the user browsing behavior comprises using a hardware-based sensor to determine a portion of interest of an online resource. In an embodiment, the hardware-based sensor comprises an eye tracking device and such an embodiment, tracking the user browsing behavior comprises tracking a user's eye movement to determine the portion of interest. In an embodiment, the hardware-based sensor comprises a motion detector and in such an embodiment, tracking the user browsing behavior comprises sensing user motion and correlating the user motion with the portion of interest. In an embodiment, at least a portion of the plurality of online resources is presented as one or more hyperlinks to navigate the user to the portion of interest of the respective online resource. The at least a portion of the plurality of online resources may be presented as one or more hyperlinks to navigate the user to the portion of interest of the respective online resource. In an embodiment, the presented plurality of online resources is ordered according to the relevance metric. In an embodiment, the portion of interest of a respective online resource is presented during a second browsing session.

At block 306, a relevance metric of the plurality of online resources is determined using the user browsing behavior, with the relevance metric measuring a relevance of the plurality of online resources in view of the context.

At block 308, the relevance metric, an indicia of the context, and the plurality of online resources are stored in a database on the computing device.

At block 310, at least a portion of the plurality of online resources is presented as one or more hyperlinks ordered according to the relevance metric.

In an embodiment, presenting the portion of interest comprises automatically scrolling the online resource to a point where the portion of interest is visible. In a further embodiment, presenting the portion of interest comprises presenting a colored indicator in a scroll bar indicating a relative position of the portion of interest in the online resource.

In an embodiment, the plurality of online resources is organized based on the relevance metric. In an embodiment, the organized plurality of online resources is presented at the computing device.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

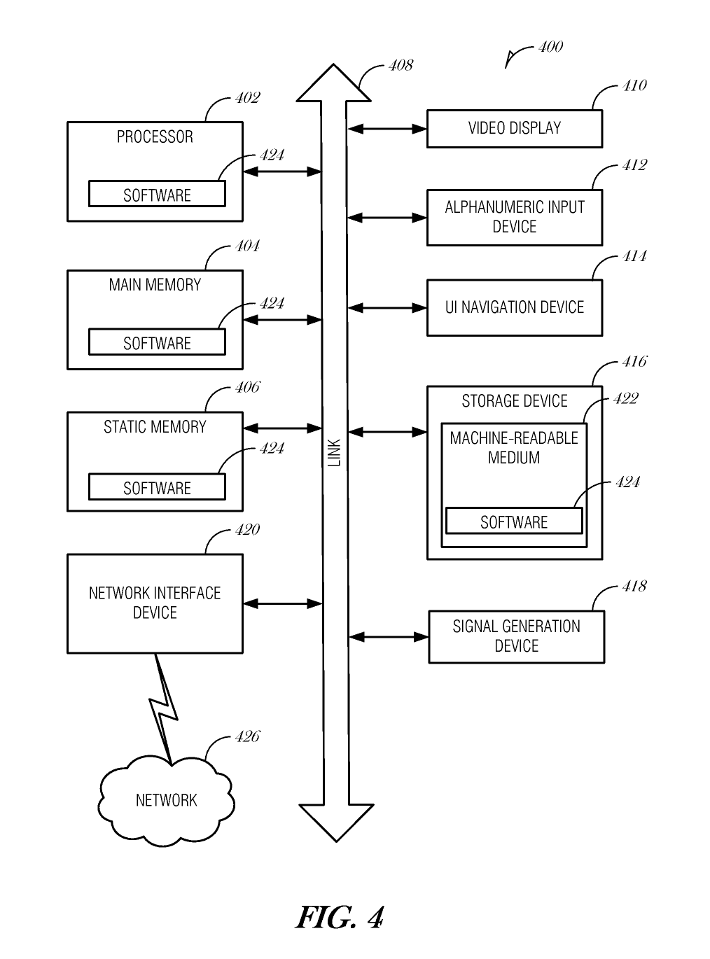

FIG. 4 is a block diagram illustrating a machine in the example form of a computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter to organize knowledge (such as a device, apparatus, or machine) comprising a system to organize knowledge, the system comprising: a processor-based system; a context identification module communicatively coupled to the processor-based system, the context identification module arranged to identify a context of a browsing session of a plurality of online resources; a tracking module communicatively coupled to the processor-based system, the tracking module arranged to track user browsing behavior during browsing of the plurality of online resources; a determination module communicatively coupled to the processor-based system, the determination module arranged to determine a relevance metric of the plurality of online resources using the user browsing behavior, the relevance metric measuring a relevance of the online resource in view of the context; and a storage module communicatively coupled to the processor-based system, the storage module arranged to store the relevance metric, an indicia of the context, and the plurality of online resources in a database on the computing device.

In Example 2, the subject matter of Example 1 may optionally include, wherein identifying the context comprises identifying a keyword used in a search string.

In Example 3 the subject matter of any one or more of Examples 1 to 2 may optionally include, wherein identifying the context comprises identifying a common topic among the plurality of online resources.

In Example 4 the subject matter of any one or more of Examples 1 to 3 may optionally include, wherein tracking the user browsing behavior comprises using a hardware-based sensor to determine a portion of interest of an online resource.

In Example 5 the subject matter of any one or more of Examples 1 to 4 may optionally include, wherein the hardware-based sensor comprises an eye tracking device and wherein tracking the user browsing behavior comprises tracking a user's eye movement to determine the portion of interest.

In Example 6 the subject matter of any one or more of Examples 1 to 5 may optionally include, wherein the hardware-based sensor comprises a motion detector and wherein tracking the user browsing behavior comprises sensing user motion and correlating the user motion with the portion of interest.

In Example 7 the subject matter of any one or more of Examples 1 to 6 may optionally include, comprising a presentation module arranged to present at least a portion of the plurality of online resources as one or more hyperlinks to navigate the user to the portion of interest of the respective online resource.

In Example 8 the subject matter of any one or more of Examples 1 to 7 may optionally include, wherein the presented plurality of online resources is ordered according to the relevance metric.

In Example 9 the subject matter of any one or more of Examples 1 to 10 may optionally include, a presentation module arranged to present the portion of interest of a respective online resource during a second browsing session.

In Example 10 the subject matter of any one or more of Examples 1 to 9 may optionally include, wherein presenting the portion of interest comprises automatically scrolling the online resource to a point where the portion of interest is visible.

In Example 11 the subject matter of any one or more of Examples 1 to 10 may optionally include, wherein presenting the portion of interest comprises presenting a colored indicator in a scroll bar indicating a relative position of the portion of interest in the online resource.

In Example 12 the subject matter of any one or more of Examples 1 to 11 may optionally include, an organization module arranged to organize the plurality of online resources based on the relevance metric.

In Example 13 the subject matter of any one or more of Examples 1 to 12 may optionally include, a presentation module arranged to present the organized plurality of online resources at the computing device.

In Example 14 the subject matter of any one or more of Examples 1 to 13 may optionally include, wherein the user browsing behavior comprises browsing behavior of a plurality of users.

Example 15 includes or may optionally be combined with the subject matter of any one of Examples 1-14 to include subject matter for organizing knowledge (such as a method, means for performing acts, machine readable medium including instructions that when performed by a machine cause the machine to performs acts, or an apparatus configured to perform) comprising identifying a context of a browsing session of a plurality of online resources; tracking user browsing behavior during browsing of the plurality of online resources; determining using a computing device, a relevance metric of the plurality of online resources using the user browsing behavior, the relevance metric measuring a relevance of the plurality of online resources in view of the context; and storing the relevance metric, an indicia of the context, and the plurality of online resources in a database on the computing device.

In Example 16, the subject matter of Example 15 may optionally include, wherein identifying the context comprises identifying a keyword used in a search string.

In Example 17 the subject matter of any one or more of Examples 15 to 16 may optionally include, wherein identifying the context comprises identifying a common topic among the plurality of online resources.

In Example 18 the subject matter of any one or more of Examples 15 to 17 may optionally include, wherein tracking the user browsing behavior comprises using a hardware-based sensor to determine a portion of interest of an online resource.

In Example 19 the subject matter of any one or more of Examples 15 to 18 may optionally include, wherein the hardware-based sensor comprises an eye tracking device and wherein tracking the user browsing behavior comprises tracking a user's eye movement to determine the portion of interest.

In Example 20 the subject matter of any one or more of Examples 15 to 19 may optionally include, wherein the hardware-based sensor comprises a motion detector and wherein tracking the user browsing behavior comprises sensing user motion and correlating the user motion with the portion of interest.

In Example 21 the subject matter of any one or more of Examples 15 to 20 may optionally include, presenting at least a portion of the plurality of online resources as one or more hyperlinks to navigate the user to the portion of interest of the respective online resource.

In Example 22 the subject matter of any one or more of Examples 15 to 21 may optionally include, wherein the presented plurality of online resources is ordered according to the relevance metric.

In Example 23 the subject matter of any one or more of Examples 15 to 22 may optionally include, presenting the portion of interest of a respective online resource during a second browsing session.

In Example 24 the subject matter of any one or more of Examples 15 to 23 may optionally include, wherein presenting the portion of interest comprises automatically scrolling the online resource to a point where the portion of interest is visible.

In Example 25 the subject matter of any one or more of Examples 15 to 24 may optionally include, wherein presenting the portion of interest comprises presenting a colored indicator in a scroll bar indicating a relative position of the portion of interest in the online resource.

In Example 26 the subject matter of any one or more of Examples 15 to 25 may optionally include, organizing the plurality of online resources based on the relevance metric.

In Example 27 the subject matter of any one or more of Examples 15 to 26 may optionally include, presenting the organized plurality of online resources at the computing device.

In Example 28 the subject matter of any one or more of Examples 15 to 27 may optionally include, wherein the user browsing behavior comprises browsing behavior of a plurality of users.

Example 29 includes or may optionally be combined with the subject matter of any one of Examples 1-28 to include a computer-readable medium including instructions that when performed by a machine cause the machine to performs any one of the examples of 1-28.

Example 30 includes or may optionally be combined with the subject matter of any one of Examples 1-28 to include subject matter for organizing knowledge comprising means for performing any one of the examples of 1-28.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. A system to organize knowledge, the system comprising:
a processor-based system;
a context identification module communicatively coupled to the processor-based system, the context identification module arranged to identify a context of a browsing session of a plurality of online resources;
a tracking module communicatively coupled to the processor-based system, the tracking module arranged to track user browsing behavior during browsing of the plurality of online resources;
a determination module communicatively coupled to the processor-based system, the determination module arranged to determine a relevance metric of the plurality of online resources using the user browsing behavior, the relevance metric measuring a relevance of the online resource in view of the context; and
a storage module communicatively coupled to the processor-based system, the storage module arranged to store the relevance metric, an indicia of the context, and the plurality of online resources in a database on the computing device.

27. The system of claim 26, wherein identifying the context comprises identifying a keyword used in a search string.

28. The system of claim 26, wherein identifying the context comprises identifying a common topic among the plurality of online resources.

29. The system of claim 26, wherein tracking the user browsing behavior comprises using a hardware-based sensor to determine a portion of interest of an online resource.

30. The system of claim 29, wherein the hardware-based sensor comprises an eye tracking device and wherein tracking the user browsing behavior comprises tracking a user's eye movement to determine the portion of interest.

31. The system of claim 29, wherein the hardware-based sensor comprises a motion detector and wherein tracking the user browsing behavior comprises sensing user motion and correlating the user motion with the portion of interest.

32. The system of claim 29, comprising a presentation module arranged to present at least a portion of the plurality of online resources as one or more hyperlinks to navigate the user to the portion of interest of the respective online resource.

33. The system of claim 32, wherein the presented plurality of online resources is ordered according to the relevance metric.

34. The system of claim 29, comprising a presentation module arranged to present the portion of interest of a respective online resource during a second browsing session.

35. The system of claim 34, wherein presenting the portion of interest comprises automatically scrolling the online resource to a point where the portion of interest is visible.

36. The system of claim 34, wherein presenting the portion of interest comprises presenting a colored indicator in a scroll bar indicating a relative position of the portion of interest in the online resource.

37. The system of claim 26, comprising an organization module arranged to organize the plurality of online resources based on the relevance metric.

38. The system of claim 37, comprising a presentation module arranged to present the organized plurality of online resources at the computing device.

39. The system of claim 26, wherein the user browsing behavior comprises browsing behavior of a plurality of users.

40. A method for organizing knowledge, the method comprising:
identifying a context of a browsing session of a plurality of online resources;
tracking user browsing behavior during browsing of the plurality of online resources;
determining using a computing device, a relevance metric of the plurality of online resources using the user browsing behavior, the relevance metric measuring a relevance of the plurality of online resources in view of the context; and
storing the relevance metric, an indicia of the context, and the plurality of online resources in a database on the computing device.

41. The method of claim 40, wherein tracking the user browsing behavior comprises using a hardware-based sensor to determine a portion of interest of an online resource.

42. The method of claim 41, wherein the hardware-based sensor comprises an eye tracking device and wherein tracking the user browsing behavior comprises tracking a user's eye movement to determine the portion of interest.

43. The method of claim 42, comprising presenting the portion of interest of a respective online resource during a second browsing session.

44. The method of claim 43, wherein presenting the portion of interest comprises automatically scrolling the online resource to a point where the portion of interest is visible.

45. A machine-readable medium including instructions for organizing knowledge, which when executed by a machine, cause the machine to:
identify a context of a browsing session of a plurality of online resources;
track user browsing behavior during browsing of the plurality of online resources;
determine using a computing device, a relevance metric of the plurality of online resources using the user browsing behavior, the relevance metric measuring a relevance of the plurality of online resources in view of the context; and
store the relevance metric, an indicia of the context, and the plurality of online resources in a database on the computing device.
